(19) United States
(12) Patent Application Publication
(10) Pub. No.: US 2023/0166995 A1
(43) Pub. Date: Jun. 1, 2023

(54) ANAEROBIC MEMBRANE BIOREACTOR COUPLED WITH UV ADVANCED DISINFECTION PROCESS FOR WASTEWATER TREATMENT

(71) Applicant: KING ABDULLAH UNIVERSITY OF SCIENCE AND TECHNOLOGY, Thuwal (SA)

(72) Inventors: Peiying HONG, Thuwal (SA); Moustapha HARB, Byblos (LB); Hong CHENG, Thuwal (SA); Nicolas AUGSBURGER, Thuwal (SA)

(21) Appl. No.: 17/921,202

(22) PCT Filed: Apr. 19, 2021
(86) PCT No.: PCT/IB2021/053210

§ 371 Date: Oct. 25, 2022

Related U.S. Application Data
(60) Provisional application No. 63/016,519, filed on Apr. 28, 2020.

(51) Int. Cl. C02F 9/00; C02F 1/32; B01D 53/48; C02F 1/72; C02F 3/28

(52) U.S. Cl. CPC C02F 9/00; C02F 1/32; B01D 53/48; C02F 1/722; C02F 3/2853; C02F 3/2806; B01D 2257/30; B01D 2258/05; C02F 1/283

(57) ABSTRACT

A wastewater treatment plant includes an anaerobic membrane bioreactor, AnMBR, unit configured to receive wastewater and to produce (1) a final permeate and (2) a gas; an oxidation disinfection unit configured to receive the final permeate and to remove biological and chemical contaminants from the final permeate to generate a final effluent; and an energy recovery unit configured to receive the gas from the AnMBR unit and generate electrical energy. The wastewater treatment plant does not use chlorination.

### CROSS-REFERENCE TO RELATED APPLICATIONS

This application claims priority to U.S. Provisional Patent Application No. 63/016,519, filed on Apr. 28, 2020, entitled “ANAEROBIC MEMBRANE BIOREACTOR COUPLED WITH UV ADVANCED DISINFECTION PROCESS FOR WASTEWATER TREATMENT,” the disclosure of which is incorporated herein by reference in its entirety.

### BACKGROUND

### Technical Field

Embodiments of the subject matter disclosed herein generally relate to a system and method for treating municipal wastewater, and more particularly, to a system that treats municipal wastewater with a combination of an anaerobic membrane bioreactor (AnMBR) and advanced oxidation disinfection unit, which not only disinfects the water, but also is an energy efficient system.

### Discussion of the Background

Water scarcity is projected to affect more than 33 countries globally by 2050. A primary factor that drives the planet towards water scarcity is the unsustainable use of non-renewable water sources for food production. More than 70% of the global non-renewable freshwaters are used for agricultural irrigation. To exemplify this issue, Saudi Arabia uses approximately 57 million m³ of groundwater per day to produce food, while the natural recharge rate of the groundwater in Saudi Arabia is very low (<3.5 million m³ of groundwater per day). A business-as-usual scenario has predicted a complete depletion of Saudi Arabia's groundwater by 2050. This is not a unique problem to Saudi Arabia, but will repeatedly be seen in arid countries that still rely on food production as their main GDP (e.g., countries in Africa, Asia).

High-quality treated wastewater has the potential to be used for agricultural irrigation, thereby alleviating water scarcity by allowing groundwater to recharge naturally. Using again Saudi Arabia as an example, considering the 33 million Saudi population and a per capita water usage rate of 250 L/d, a full capture, treatment and reuse of this water would account for about 15% of the water demand needed to produce food. The current production rate of treated wastewater is already more than the natural groundwater recharge rate in Saudi Arabia, and is projected to increase as urban population grows. However, the reuse of treated wastewater for food production must come at no compromise on food and environmental safety. It is generally recognized that wastewater must therefore be cleaned with a membrane-based treatment process, and disinfected by maintaining a residual chlorine of 0.5 mg/L prior to reuse.

The membrane-based treatment process is achieved by retrofitting membranes to an existing aerobic activated sludge tank (thereby referred to as aerobic membrane bioreactor, AeMBR). The coupling of a membrane can provide an additional physical removal of contaminants, hence achieving an improved water quality. However, it was reported that the average energy consumption range is from 0.7 to 2.5 kWh/m³ for AeMBR. Assuming a wastewater treatment plant designed to treat 4,000 m³ wastewater per day, this would equate to 10,000 kWh needed.

Anaerobic digestion of the sludge can generate methane, which is an energy source that can be converted to electrical energy at a current technological efficiency of 40% (i.e., generates 3 kWh per m³ methane). Hence, anaerobic digestion of sludge is commonly argued as an approach to improve the overall sustainability of treating wastewater in the current wastewater treatment plant. However, the daily sludge production of an aerobic activated sludge process conventional wastewater treatment plant is estimated to be about 101 kg per day per 1,000 m³wastewater treated, and with an estimated chemical oxygen demand (COD) ranging from 6,000 to 90,000 g per m³ of sludge. This only translates to 2.7 to 39.8 kWh energy recovered from the anaerobic digestion, contributing to less than 1% of the energy demand needed by the AeMBR. After digestion, the sludge still needs to be landfilled or incinerated, hence incurring additional solid disposal costs.

Thus, there is a need for a new system that is capable of treating the wastewater in an efficient way with minimum energy consumption.

### BRIEF SUMMARY OF THE INVENTION

According to an embodiment, there is a wastewater treatment plant that includes an anaerobic membrane bioreactor, AnMBR, unit configured to receive wastewater and to produce (1) a final permeate and (2) a gas, an oxidation disinfection unit configured to receive the final permeate and to remove biological and chemical contaminants from the final permeate to generate a final effluent, and an energy recovery unit configured to receive the gas from the AnMBR unit and generate electrical energy. The wastewater treatment plant does not use chlorination.

According to another embodiment, there is a method for treating wastewater, and the method includes supplying wastewater to an anaerobic membrane bioreactor, AnMBR, unit, to produce (1) a final permeate and (2) a gas, supplying the final permeate to an oxidation disinfection unit to remove biological and chemical contaminants from the final permeate to generate a final effluent, and burning the gas from the AnMBR unit at an energy recovery unit to generate electrical energy. The wastewater treatment plant does not use chlorination.

According to yet another embodiment, there is a wastewater treatment plant that includes an anaerobic tank configured to receive wastewater and to produce (1) an initial permeate and (2) methane, a membrane unit fluidly connected to the anaerobic tank and configured to filter the initial permeate with one or more membranes to generate a final permeate and also to generate methane, an ultra-violet, UV, generating unit located in a UV tank, which is fluidly connected to the membrane unit, the UV generating unit being configured to generate UV light to inflict damage to extracellular material present in the final permeate to generate an initial effluent, a granular activated carbon unit fluidly connected to an output of the UV tank, and configured to absorb remnant chemical and organic contaminants from the initial effluent to generate a final effluent, and an energy recovery unit configured to receive the methane from the anaerobic unit and from the membrane unit to generate electrical energy. The wastewater treatment plant does not use chlorination.

### BRIEF DESCRIPTION OF THE DRAWINGS

Fora more complete understanding of the present invention, reference is now made to the following descriptions taken in conjunction with the accompanying drawings, in which:

FIG. 1 is a schematic diagram of a wastewater treatment plant that uses an anaerobic approach combined with a disinfectant unit free of chlorination for cleaning the wastewater;

FIG. 2 is a flow chart of a method for treating the wastewater for reusing the water;

FIG. 3 is a schematic diagram of another wastewater treatment plant that uses an anaerobic approach combined with a disinfectant unit, which is free of chlorination, for cleaning the wastewater; and

FIG. 4 is a flow chart of another method for treating the wastewater with no chlorination and no sedimentation clarifiers.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a wastewater treatment plant that uses four units for treating the wastewater. However, the embodiments to be discussed next are not limited to such a configuration, and it may be implemented with a different number of units.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As discussed in the Background section, sludge management has traditionally been a precursor to energy recovery from wastewater, but new technologies can now turn large volumes of wastewater, and not sludge, into a direct resource for energy recovery. Thus, according to an embodiment, an anaerobic membrane bioreactor (AnMBR) is used first to clean large volumes of municipal wastewater, directly converting the organic carbon in the wastewater to volatile fatty acids (e.g., acetate, butyrate, and propionate) and gas (e.g., carbon dioxide and hydrogen). The volatile fatty acids and gas are in turn used by archaeal methanogens to generate methane. Most municipal wastewater contains ca. 500 mg COD/L, hence a wastewater treatment plant treating 4,000 m³ wastewater would be generating 730 m³ methane (or 2,190 kWh energy). Thus, according to an embodiment, it is possible to optimize the AnMBR operation to a level that balances out the energy demand with the amount of energy generated so that the entire process/system becomes energy-neutral. An additional advantage of the AnMBR process is that the sludge production volume is low, the process is operated with a long sludge retention time and generally should produce up to 10× lower sludge volume than the aerobic MBR.

Ammonia are not removed by anaerobic microorganisms and are typically retained after AnMBR treatment in the range of 20 to 50 mg/L. The presence of ammonia in the post-AnMBR effluent can be a double-edged sword. On one hand, it makes the effluent advantageous for direct use in agricultural irrigation since ammonia can be taken up by plants for growth. On the other hand, the water cannot be disinfected with chlorine to prevent microbial regrowth as the direct use of chlorine on such ammonia-rich waters will produce nitrogenous disinfection byproducts (e.g., N-nitroso NDMA), which have been shown to be carcinogenic and mutagenic. In fact, most disinfection byproducts (DBPs) produced through chlorine disinfection, regardless of whether they are in contact with post-aerobic or anaerobic treatment process, are regarded as carcinogenic, genotoxic and mutagenic chemical contaminants. The inventors have previously shown that DBPs can trigger horizontal gene transfer, in which naturally competent bacteria experiences increase in integration of foreign DNA into their chromosomes. This allows them to increase new functional gene traits and can be particularly problematic if the additional trait is associated with antibiotic resistance or virulence, as it would increase disease burden.

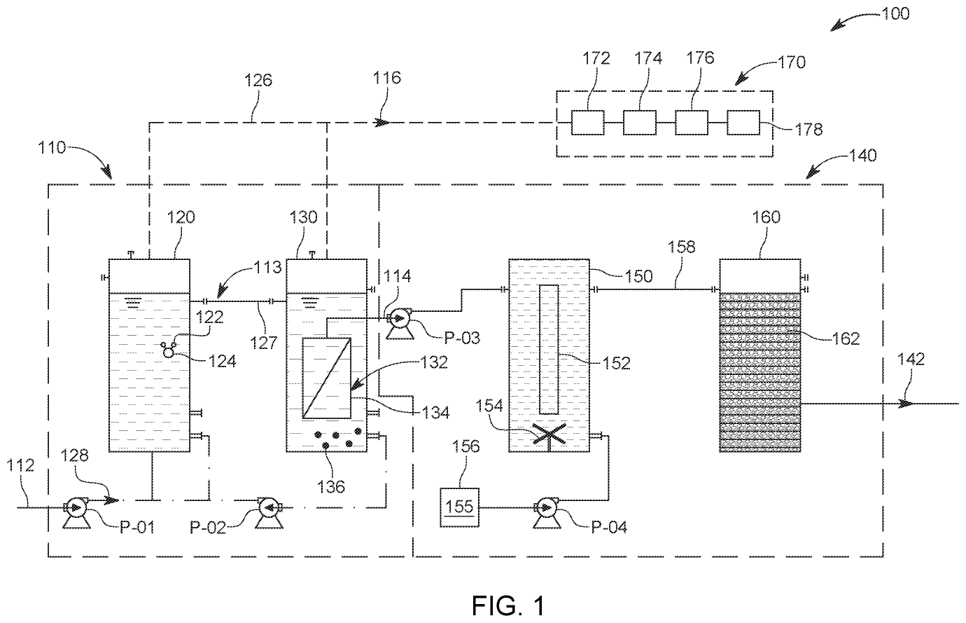

Considering these problems associated with the chlorine treatment, in one embodiment, the post-AnMBR effluent is treated with a non-chlorine form of advanced disinfection process. The advanced disinfection process can be in the form of (1) UltraViolet (UV)/H₂O₂ or (2) ozone coupled with UV/H₂O₂, followed by granular activated carbon (GAC), which is used for a final cleaning step. The UV light does not generate DBPs. The UV light is able to cause direct damage to extracellular DNA that are typically not removed effectively by MBR. This means that even if the genes were to be taken up by bacteria and integrated into their chromosomal genome, they cannot be expressed into any meaningful gene products, and would therefore not be a cause of concern. GACs can provide adsorption of any remnant chemical or organic contaminants that may be present at this final stage of treatment. A plant that has these capabilities is now discussed with regard to FIG. 1.

FIG. 1 shows a plant 100 that has a 2-stage AnMBR unit 110 that is configured to receive wastewater 112 and to produce a final permeate 114 that is free of most of the waste from the wastewater 112. The final permeate 114 is supplied to a disinfection unit 140 for further removing bacteria and microbes and generating a final effluent 142, that can be discharged back into the ground or can be used for irrigation. The plant 100 further includes an energy recovery unit 170 that is configured to receive a gas 116 produced by the 2-stage AnMBR unit 110 and use this gas to generate electricity, which is used to power up the plant 100. Each of these units are now discussed in more detail.

The 2-stage AnMBR unit 110 includes a first stage module 120, e.g., an anaerobic tank, that contains anaerobic microorganisms 122 attached to a carrier substratum 124. The anaerobic microorganisms 122 can include any known anaerobic microorganism. The same is true for the substratum 124. The attached-mode configuration is designed to facilitate interaction and cross-feeding between bacterial fermenters and archaeal methanogens. This configuration is also anticipated to minimize carry-over of mixed liquor suspended solids (MLSS) to the second stage module 130, i.e., a membrane unit, which contains a submerged microfiltration (MF) membrane unit 132, and hence decreases the membrane fouling rate. The MF membrane unit 132 may include one or more MF membranes 134 for removing solids from the wastewater 112. Earlier studies have suggested that the MLSS concentration should be kept at a low level to help mitigate membrane fouling. MF membranes 134 are used in this embodiment as the inventors have previously shown that they are able to achieve up to 5-log removal of antibiotic resistant bacteria and antibiotic resistance genes after experiencing optimal level of fouling [1], and do not require as much energy to operate as nanofiltration or ultrafiltration membranes. The first AnMBR module 120 is fluidly connected to the energy recovery unit 170, through a corresponding pipe 126, and the pipe supplies the gas generated by the anaerobic microorganisms 122, due to the interaction with the solids from the wastewater, to the energy recovery unit for generating electricity or to some other systems that can add value to the resource recovery process.

An initial permeate 113 from the first AnMBR module 120 enters along a pipe 127 into the second stage module 130 and passes through the one or more MF membranes 134 discussed above, for further removing solids and contaminants from the initial permeate 113. The final permeate 114 that is generated by the MF membranes 134 is then moved to the disinfection unit 140. To move the wastewater and various permeates through the 2-stage AnMBR unit 110, one or more pumps may be used. For example, as shown in FIG. 1, the first AnMBR module 120 may include a first pump P-01 that pumps the wastewater 112 into the first AnMBR module 120, for example, at its bottom. A second pump P-02 may be fluidly connected to the bottom of the second stage module 130 to move the sludge 136 back to the first AnMBR module 120. One or more valves 128 may be provided along the pipes to control the flow of the various fluids.

The final permeate 114 from the 2-stage AnMBR unit 110 is pumped with a third pump P-03 to the disinfection unit 140. While FIG. 1 shows the third pump P-03 being part of the disinfection unit 140, in one embodiment, this pump may be part of the 2-stage AnMBR unit 110. The final permeate 114 enters into a UV disinfection module 150, which is configured to apply a combination of (1) UV light and H₂O₂ or (2) ozone coupled with UV/H₂O₂. For this purpose, the UV disinfection module 150 includes a UV generating unit 152, which is shown in the figure being placed completely inside the module 150. However, in one embodiment, it is possible to have the UV generating unit 152 placed outside the module 150, and the UV light may be directed to an inside of the module 150. In one application, a stirring device 154 may also be placed inside the module 150 for stirring the permeate 114, so that the fluid is better exposed to the UV radiation.

The UV light is chosen as the disinfection strategy because the post-MBR permeates 114 are typically of low turbidity and allow good UV penetration throughout the water medium. UV is effective in causing direct damage to extracellular DNA that are not effectively removed by the MBR. If hydrogen peroxide H₂O₂ 155 is further added to the module 150, then it can be supplied from another tank 156, and can be pumped with pump P-04 into the module 150, as shown in FIG. 1. The H₂O₂ 155 achieves enhanced removal of chemical contaminants (e.g., pharmaceutical compounds and antibiotics). The UV/H₂O₂ treatment does not generate the traditional DBPs expected from chlorine, but the breakdown of the pharmaceutical compounds and antibiotics during the interaction with the H₂O₂ can lead to unintentional deleterious intermediate byproducts. Thus, the use of ozone coupled with UV/H₂O₂ is also beneficial as ozone in the presence of ammonia can effectively inactivate microbial and chemical contaminants with minimal bromate formation. If ozone is used, it can be either produced directly inside the tank 150, for example, using electrical discharges between two electrodes, or it can be stored in an additional tank, and supplied to the tank 150.

As discussed above, most of the existing plants use chlorine for inactivating microorganism. In contrast with chlorine, the UV light is able to efficiently inactivate microorganisms due to dimerization of pyrimidine bases in DNA when energy is absorbed in the UV-C range. UV can also impede possible horizontal gene transfer via conjugation and natural transformation without generating disinfection byproducts. However, UV alone via photolysis cannot proficiently remove contaminants of emerging concern (CECs), hence there is a need to supplement an oxidant such as H₂O₂ which has been shown to enhance the removal of pharmaceutical compounds in combination with UV. UV/H₂O₂ advanced oxidation process (AOP) is therefore proposed as a treatment option for the removal of CECs from ammonia-rich AnMBR effluent 114. Ammonia is about 97% transparent to the monochromatic light emitted by low-pressure UV lamps (254 nm), and hence the UV would be transmitted through the water matrix effectively to inactivate ARG and ARB. UV reacts with H₂O₂ to generate hydroxyl radicals that degrade pharmaceutical compounds.

Regardless of the disinfectant method applied in the module 150, an additional GAC column 160 is incorporated into the disinfection unit 140 to achieve a final adsorption and removal of potential contaminants that may arise. The GAC becomes over time a biological activated carbon (BAC), which can serve to further remove some of the organic constituents present in the treated wastewater. The initial effluent 158 generated by the module 150 is fed to the GAC column 160, where it encounters the activated carbon 162. After interacting with the activated carbon 162, the final effluent 142 is taken out of the disinfectant module 140, and used either for agricultural purposes or returned to the ground.

The gas 116 generated by the 2 stage-AnMBR module 110, which is typically methane, but it may include other gases as well, is provided to the recovery unit 170. Note that each unit 120 and 130 of the module 110 can generate the gas 116. The recovery unit 170 may include a gas storage unit 172 for storing the gas, and a gas burning unit 174, for burning the gas and transforming its energy into electrical energy. The recovery unit 170 may further include an electricity storage unit 176, for example, batteries, for storing the generated electrical energy. In one application, solar panels 178 or equivalent renewable energy sources may also be provided for charging the electricity storage unit 176.

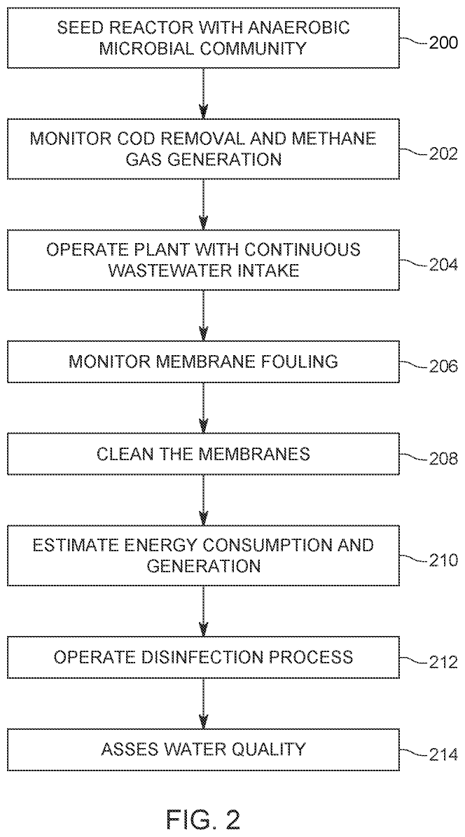

To operate the plant 100, according to one embodiment illustrated in FIG. 2, the first stage module 120 is seeded in step 200 with anaerobic microbial community, which is currently available in lab-scale reactors. The first stage AnMBR module 120 is initially operated in batch mode to allow acclimatization of the microorganisms to the raw wastewater 112. The raw wastewater 112 is collected from equalization tanks where the untreated wastewater is stored. Batch mode operation continues until the AnMBR achieves stabilization. This stabilization phase is then evaluated in step 202 based on the rate of COD removal and methane gas generation, and is defined as the plateau phase for these measured parameters over a course of at least 2 consecutive weeks.

Once the stabilization of the reactor is achieved, the batch mode operation ceases, and the entire system receives raw wastewater in a continuous mode in step 204. For this phase, the plant 100 is operated for a couple of months at hydraulic retention time (HRT), sludge retention time (SRT) and membrane scouring rates reported to be optimal from pilot studies conducted by others in the art. Thereafter, for this period of time, the plant 100 is operated based on optimal parameters made available from the life cycle (LCA) and technoeconomic (TEA) analysis performed as discussed later. Throughout the operation, occurrence of membrane fouling is continuously monitored in step 206 using transmembrane pressure (TMP) as an indicator. The membranes 134 are operated in intermittent filtration mode, which consist of a filtration and relaxation phase, as a means of fouling control strategy. Backwashing is done when the TMP suggests early stage critical fouling. Typically, the backwashing efficiency decreases with each cycle of wash. Maintenance cleaning on the membranes is performed when backwashing is no longer efficient. A combination of citric acid, UV and bacteriophages can be used for cleaning the membranes 134 in step 208. The aim of this step is to decrease the amount of citric acid used and recirculated into the first stage by achieving synergistic cleaning efficiency through the use of UV and bacteriophages. Recovery cleaning, which involves placing the membranes offline and soaking them in 1 g/L sodium hypochlorite for 4-6 h, may also be carried out, but not very often, as such cleaning procedure is usually only conducted after about 3-4 years of continuous operation.

During the course of operation, energy costs associated with the various pumps illustrated in FIG. 1 are collected along with the energy production rates (in terms of methane gas production). The energy associated with the backwashing and the cleaning frequencies are also recorded. The costs of the used chemicals (e.g., H₂O₂, citric acid) and the amount of sludge produced for solid waste disposal are also determined as all these values are used toward optimizing the LCA/TEA models.

In step 212, an advanced disinfection process is performed. The final permeate 114 of the AnMBR module 110 is disinfected in the UV/H₂O₂ module 150 when operated with a low pressure UV 254 nm reactor dosed with, for example, 30 mg/L H₂O₂, and designed with a contact time, for example, of 15 min. Those skilled in the art would understand that these numbers are just an example and other values can be used. In lab (i.e., small-scale systems), the inventors have obtained approximately 2.5-log reduction of extracellular DNA by this advanced disinfection process. Log removal values of one or more tracer indicators is monitored before and after disinfection, and after the GAC column 160. The turbidity of the post-AnMBR effluent is monitored as an increase in the turbidity results in poor UV efficacy due to light scattering and limited light penetration. The pH is also monitored as it affects the formation of nitrate and reactive oxygen species from H₂O₂. Both parameters are then correlated with the log removal values of tracer compound. This allows the operator to determine the range of acceptable turbidity and pH fluctuations permissible in a continuous system. Energy costs associated with the disinfection are optimized with the LCA/TEA models.

The water quality is assessed in step 214. The water quality of the final effluent 142 is assessed in accordance to the local regulations. Samples are collected on alternate days throughout the operation at different stages of the plant. All final treated effluent samples are measured for COD, ammonia, nitrate, phosphate, coliforms and heavy metals. COD, ammonia, nitrate and phosphate measurements are done using Hach kits on-site. Total and fecal coliforms are enumerated based on simultaneous enzymatic agar (e.g., Chromocult), and test results are further verified with an in-house developed functional DNAzyme-based biosensors targeting E. coli. Heavy metal concentrations are also determined.

During the course of operation of the plant 100 discussed above, energy costs associated with pumps, UV lamps, etc., are collected along with energy production rates (in terms of methane gas production). Backwashing and cleaning frequencies are also recorded. The costs of chemicals (e.g., H₂O₂, citric acid) are estimated and all these values are used by the LCA and TEA to finetune the operation of each component, so that the entire plant achieves or tends to achieve energy neutral status at the minimal.

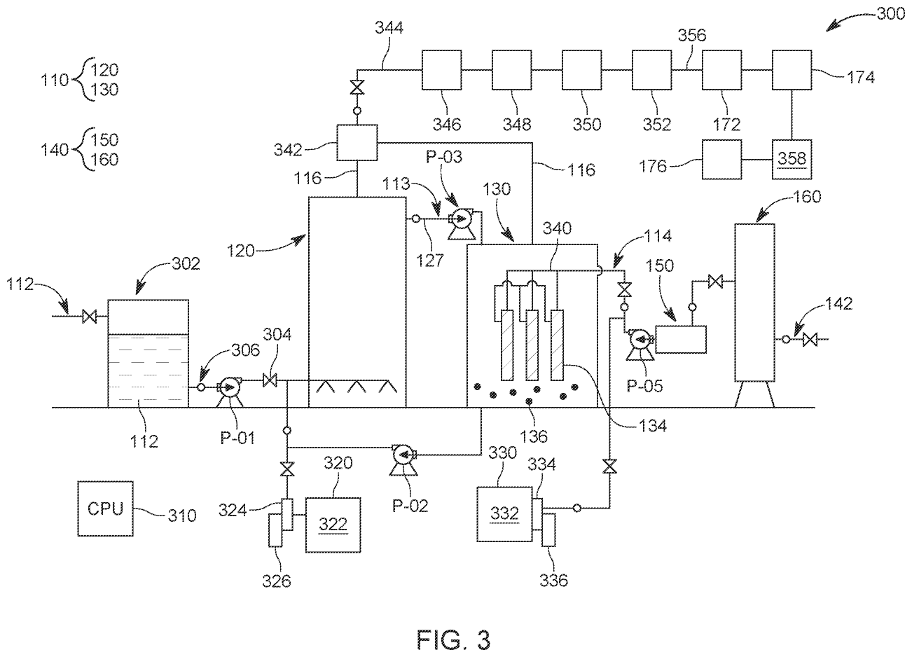

A variation of the plant 100 discussed above may be implemented as illustrated in FIG. 3. The plant 300 has some of the elements of the plant 100, which are labeled by the same reference numbers as in FIG. 1, and the description of those elements is omitted herein. Further, the plant 300 is shown to have an equalization tank 302 that receives first the wastewater 112. The inlet pump P-01 is connected to the equalization tank 302 and pumps the wastewater 112 into the first stage module 120 of the 2-stage AnMBR unit 110. Most of the pipes connecting the various units and modules are provided with one or more valves 304 and one or more sensors 306. The valves may be manual or electronically activated. The sensors may be temperature, pressure, and flowmeter sensors. All these electronic devices may be connected to a computing unit 310, in a wired or wireless manner. The computing unit 310 may be programmed with software commands for opening or closing the valves, based on the measured readings from the sensors 306, to efficiently remove the microorganisms from the wastewater. The pumps may also be functionally connected to the computing unit 310 so that their on and off states and their speed is controlled by the computing unit 310.

FIG. 3 further shows a chemical storing tank 320 that stores one or more chemicals or anaerobic microorganism 322, which may be used for injection into the first stage module 120. An automatic dosimeter 324 is attached to the tank 320 and controlled by the computing unit 310 for providing the desired chemical or anaerobic microorganism or a combination of them. Another chemical storing tank 330 is fluidly linked to the second stage module 130 and stores one or more chemicals 332 that are used to clean the membranes 134. A dosing device 334, which may be controlled by the computing device 310, is fluidly connected to the tank 330, to provide, when necessary, the chemicals 332. Corresponding pumps 326 and 336 may be also associated with these tanks for pumping the corresponding chemicals to the corresponding tanks.

FIG. 3 further show plural membranes 134 located inside the second stage module 130, and the plural membranes are fluidly connected in parallel with a pipe manifold 340. The gas 116 from the first and/or second stage modules 120, 130 is provided to a gas liquid separator 342, which is configured to separate the gas 116 from the fluids that are present inside these modules. The separated gas 344 is then provided to a water seal tank 346, another gas water separator 348 that traps the water, a first desulfurization tank 350 and a second desulfurization tank 352, to remove the sulfur from the separated gas 344. The produced desulfurization gas 356 may then be stored in the storage unit 172, and then is eventually burned in the burning unit 174 to produce steam. The steam is supplied to an electrical current generator 358 to produce electrical current. The electrical power may be stored in the electrical energy storage unit 176. The electrical power is then supplied back to the various elements of the plant 300, for example, pumps, computing unit, sensors, UV module, etc. It is noted that neither the plant 100 nor the plant 300 uses chlorination or chlorination tanks. In one application, these plant also do not use sedimentation clarifiers.

With increasing population growth and urbanization, wastewater treatment is valued to be a 10 billion USD market, with a projected 6% growth per annum, driven mainly by emerging markets in Middle East, Africa, China, and India. Global wastewater networks are not deployed universally and have significant room for improvement. It is envisioned that the proposed plants 100 and/or 300 can fit into this growing market. This is because the majority of developing markets e.g., China and India are looking into decentralized wastewater treatment technologies so as to increase flexibility in demand management as new cities develop. Globally, there is also an increasing demand for sustainable wastewater treatment to maximize profit margins by decreasing energy costs associated with treating the wastewater, and subsequently supplying the treated wastewater to end users at a certain market price for reuse purposes. To exemplify, energy costs in Saudi Arabia is on average 5c per kWh but globally, energy costs are marked at an average of 11c per kWh. Hence, as the plant 100/300 is able to achieve energy neutrality/positivity with using AnMBR to treat the wastewater, it significantly increases the profit margins in reselling water for reuse. In addition, the COVID-19 pandemic has also amplified the concept of deurbanization, in which new developments are moving away from big, megacities to satellite cities (i.e., deurbanization). In such instance, decentralized wastewater treatment plant using the technology described in these embodiments would serve to treat the wastewater in an efficient manner and facilitate direct reuse of those wastewater to maintain green living spaces.

Energy costs of the UV/H₂O₂ based plant 100/300 depend on the contaminants of interest and the flow rate of the system. Reported energy consumption rate for removing 100 mg/L styrene contaminant at a flow rate of 3 m/s is about 0.27 kWh/m³. As the municipal wastewater is not expected to have such high concentrations of recalcitrant chemical compound, the energy consumption rate is therefore anticipated to be lower than 0.3 kwh/m³. Although the energy costs associated with the AnMBR module and the advanced disinfection process are relatively inexpensive compared to the aerobic systems, the chemical and membrane costs can contribute to a significant portion of the operating expenditures (OPEX) of plant 100/300. An earlier study noted that the use of Fe can serve as a membrane flux enhancer, improve permeate quality as they facilitate coagulation of soluble colloids and improve purity of the biogas. Thus, in one embodiment, the post-AnMBR effluent is not disinfected and instead, is directly fed into a nature-based filtration system that makes use of local indigenous plants grown on top of sand filtration beds. The plants assimilate the ammonia and phosphate, thereby removing these nutrients from the AnMBR effluent. At the same time, sand filtration beds achieve removal of contaminants that may be present, and the final treated water can be used for urban landscaping or toilet flushing.

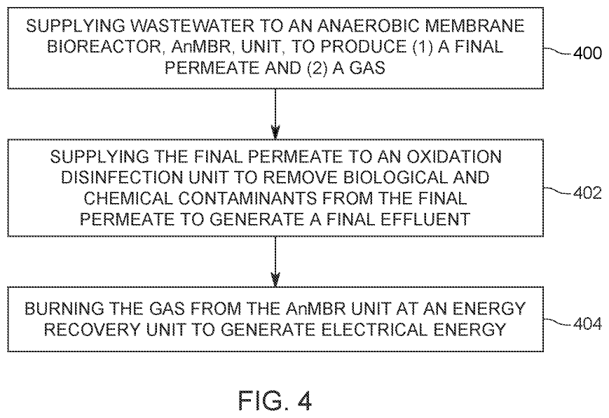

A method for treating wastewater with one of the above plants is now discussed with regard to FIG. 4. The method includes a step 400 of supplying wastewater to an anaerobic membrane bioreactor, AnMBR, unit 110, to produce (1) a final permeate 114 and (2) a gas 116, a step 402 of supplying the final permeate 114 to an oxidation disinfection unit 140 to remove biological and chemical contaminants from the final permeate 114 to generate a final effluent, and a step 404 of burning the gas from the AnMBR unit 110 at an energy recovery unit 170 to generate electrical energy. The wastewater treatment plant does not use chlorination.

In one application, no sedimentation clarifiers are used. The method may further include a step of holding microorganisms at a first stage module of the AnMBR unit to anaerobically convert organic carbon from the wastewater into the gas and generate an initial permeate, and a step of supplying the initial permeate to a second stage module of the AnMBR unit to remove plural chemicals by using one or more membranes. The method may also include a step of generating ultra-violet, UV, light with a UV generating unit, which is located in a UV tank, wherein the UV light inflicts damage to extracellular material present in the final permeate, and/or a step of absorbing remnant chemical and organic contaminants from the final effluent with a granular activated carbon unit that is fluidly connected to an output of the UV tank. In one embodiment, the method may include a step of stirring the final permeate with a stirring device located inside the UV tank, and/or a step of storing the gas at a gas storage unit, and/or a step of burning the gas at a gas burning unit to generate the electrical energy. The method may further include a step of storing the electrical energy generated by the gas burning unit at an electrical storage unit, and/or a step of generating additional electrical energy with a solar panel, wherein the solar panel is electrically connected to the electrical storage unit. The method may also include a step of holding hydrogen peroxide at a hydrogen peroxide tank, and/or a step of pumping with a pump, which is fluidly connecting the hydrogen peroxide tank to the UV tank, the hydrogen peroxide from the hydrogen peroxide tank into the UV tank.

The disclosed embodiments provide a wastewater treatment plant that uses an anaerobic membrane bioreactor and advanced oxidation disinfection for treating the wastewater. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A wastewater treatment plant comprising:
an anaerobic membrane bioreactor, AnMBR, unit configured to receive wastewater and to produce (1) a final permeate and (2) a gas;
an oxidation disinfection unit configured to receive the final permeate and to remove biological and chemical contaminants from the final permeate to generate a final effluent; and
an energy recovery unit configured to receive the gas from the AnMBR unit and generate electrical energy,
wherein the wastewater treatment plant does not use chlorination.

2. The treatment plant of claim 1, wherein there are no sedimentation clarifiers.

3. The treatment plant of claim 1, wherein the AnMBR unit comprises:
a first stage module configured to hold microorganism selected to anaerobically convert organic carbon from the wastewater into the gas and generate an initial permeate; and
a second stage module configured to receive the initial permeate and remove plural chemicals by using one or more membranes.

4. The treatment plant of claim 3, wherein the oxidation disinfection unit comprises:
an ultra-violet, UV, generating unit located in a UV tank and configured to generate UV light to inflict damage to extracellular material present in the final permeate; and
a granular activated carbon unit fluidly connected to an output of the UV tank, and configured to absorb remnant chemical and organic contaminants from the final effluent.

5. The treatment plant of claim 4, further comprising:
a stirring device located inside the UV tank and configured to stir the final permeate.

6. The treatment plant of claim 1, wherein the energy generating unit comprises:
a gas storage unit configured to store the gas; and
a gas burning unit configured to burn the gas and generate electrical energy.

7. The treatment plant of claim 6, further comprising:
an electrical storage unit configured to store the electrical energy generated by the gas burning unit.

8. The treatment plant of claim 7, further comprising:
a solar panel configured to generate electrical energy,
wherein the solar panel is electrically connected to the electrical storage unit.

9. The treatment plant of claim 4, wherein the oxidation disinfection unit further comprises:
a hydrogen peroxide tank configured to hold hydrogen peroxide; and
a pump fluidly connecting the hydrogen peroxide tank to the UV tank and configured to move the hydrogen peroxide from the hydrogen peroxide tank into the UV tank.

10. A method for treating wastewater, the method comprising:
supplying wastewater to an anaerobic membrane bioreactor, AnMBR, unit, to produce (1) a final permeate and (2) a gas;
supplying the final permeate to an oxidation disinfection unit to remove biological and chemical contaminants from the final permeate to generate a final effluents; and
burning (404) the gas from the AnMBR unit at an energy recovery unit to generate electrical energy,
wherein the wastewater treatment plant does not use chlorination.

11. The method of claim 10, wherein no sedimentation clarifiers are used.

12. The method of claim 10, further comprising:
holding microorganisms at a first stage module of the AnMBR unit to anaerobically convert organic carbon from the wastewater into the gas and generate an initial permeate; and
supplying the initial permeate to a second stage module of the AnMBR unit to remove plural chemicals by using one or more membranes.

13. The method of claim 12, further comprising:
generating ultra-violet, UV, light with a UV generating unit, which is located in a UV tank, wherein the UV light inflicts damage to extracellular material present in the final permeate; and
absorbing remnant chemical and organic contaminants from the final effluent with a granular activated carbon unit that is fluidly connected to an output of the UV tank.

14. The method of claim 13, further comprising:
stirring the final permeate with a stirring device located inside the UV tank.

15. The method of claim 10, further comprising:
storing the gas at a gas storage unit; and
burning the gas at a gas burning unit to generate the electrical energy.

16. The method of claim 15, further comprising:
storing the electrical energy generated by the gas burning unit at an electrical storage unit.

17. The method of claim 16, further comprising:
generating additional electrical energy with a solar panel,
wherein the solar panel is electrically connected to the electrical storage unit.

18. The method of claim 13, further comprising:
holding hydrogen peroxide at a hydrogen peroxide tank; and
pumping with a pump, which is fluidly connecting the hydrogen peroxide tank to the UV tank, the hydrogen peroxide from the hydrogen peroxide tank into the UV tank.

19. A wastewater treatment plant comprising:
an anaerobic tank configured to receive wastewater and to produce (1) an initial permeate and (2) methane;
a membrane unit fluidly connected to the anaerobic tank and configured to filter the initial permeate with one or more membranes to generate a final permeate and also to generate methane;
an ultra-violet, UV, generating unit located in a UV tank, which is fluidly connected to the membrane unit, the UV generating unit being configured to generate UV light to inflict damage to extracellular material present in the final permeate to generate an initial effluent;
a granular activated carbon unit fluidly connected to an output of the UV tank, and configured to absorb remnant chemical and organic contaminants from the initial effluent to generate a final effluent; and
an energy recovery unit configured to receive the methane from the anaerobic unit and from the membrane unit to generate electrical energy,
wherein the wastewater treatment plant does not use chlorination.

20. The treatment plant of claim 19, wherein there are no sedimentation clarifiers.
